(19) United States
(12) Patent Application Publication
(10) Pub. No.: US 2003/0161293 A1
(43) Pub. Date: Aug. 28, 2003

(54) Router, method of administrating data transfer routes, and computer program for doing the same

(75) Inventor: Kazunori Kamachi, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/370,590

(22) Filed: Feb. 24, 2003

(30) Foreign Application Priority Data
Feb. 27, 2002 (JP) 2002-051243

(51) Int. Cl. H04L 12/28

(52) U.S. Cl. 370/351; 370/399

(57) ABSTRACT

A router includes unicast protocol engines each receiving a unicast route from an adjacent node, a routing software core which stores the unicast route into trees associated with the unicast protocol engines, selects a best route among unicast routes received by the unicast protocol engines, in accordance with a priority assigned to the unicast protocol engines, and stores the best route into a best route tree, and a kernel which receives the best route from the routing software core to carry out routing control. The routing software core, when a plurality of routes addressed to a common destination is stored into the trees, registers a route retrieved by a unicast protocol engine having a highest priority, into the best route tree as a best route, applies a priority to routes retrieved by other unicast protocol engines, in accordance with a priority assigned to the unicast protocol engines, and registers the routes into the best route tree together with the best route as a best route candidate.

### BACKGROUND OF THE INVENTION

1. Field of the Invention

The invention relates to a router, specifically, an apparatus for administrating information about a route through which data is transmitted, through the use of a tree structure. The invention relates further to a method of doing the same, and a computer program for causing a computer to do the same.

2. Description of the Related Art

In order to transfer packets among networks, a routing table in which information about a route through which data is transmitted is stored in a tree structure is generally stored in a router or computer. After connected to a network such as internet, a router or computer starts transferring packets in accordance with such a routing table.

FIG. 1 is a block diagram of a conventional router.

The router 50 illustrated in FIG. 1 is comprised of a first routing engine (RE) 10, a second routing engine (RE) 11, a third routing engine (RE) 12, a demon routing software core (RS-CORE) 13 which merges routes provided from the first to third routing engines 10 to 12, and registers the routes into a later mentioned kernel 14, and a kernel 14 which stores routes provided from the routing software core 13, into a forwarding route table to thereby carry out routing control.

The first to third routing engines 10, 11 and 12 operate in accordance with unicast protocols different from one another.

The routing software core (RS-CORE) 13 includes a first tree 10A in which a route retrieved by the first routing engine 10 is stored, a second tree 11A in which a route retrieved by the second routing engine 11 is stored, a third tree 12A in which a route retrieved by the third routing engine 12 is stored, and a best route tree 13A in which a best route found among routes stored in the first to third trees 10A, 11A and 12A is stored.

Hereinbelow is explained an operation of the router 50 with reference to FIGS. 2 to 6.

FIG. 2 illustrates a network structure in which seven routers A to G are connected to one another through networks R1 to R8.

When the router A transfers packets to the network R8 in the network structure illustrated in FIG. 2, packets can be transferred through three routes. In a first route, packets are transferred to the network R8 through the routers B and E. In a second route, packets are transferred to the network R8 through the routers C and E. In a third route, packets are transferred to the network R8 through the routers D, F and E.

The first to third routing engines 10 to 12 operate in accordance with routing protocols different from one another. The first routing engine 10 retrieves NEXTHOP (B) as a route to a destination, that is, the network R8 in accordance with a routing protocol S, and stores the route NEXTHOP (B) into the first tree 10A in the routing software core 13. The second routing engine 11 retrieves NEXTHOP (C) as a route to a destination, that is, the network R8 in accordance with a routing protocol T, and stores the route NEXTHOP (C) into the second tree 11A in the routing software core 13. The third routing engine 12 retrieves NEXTHOP (D) as a route to a destination, that is, the network R8 in accordance with a routing protocol U, and stores the route NEXTHOP (D) into the third tree 12A in the routing software core 13.

It is assumed hereinbelow that the second routing engine 11 has a highest priority, the first routing engine 10 has a second highest priority, and the third routing engine 12 has a lowest priority in the routing software core 13. It is further assumed that the best route tree 13A initially stores no routes.

As illustrated in FIG. 3, when the first routing engine 10 stores the route NEXTHOP (B) to the network R8, having been retrieved by the first routing engine 10, into the routing software core 13, the route NEXTHOP (B) is stored in the first tree 10A associated with the first routing engine 10. Then, the route NEXTHOP (B) is stored into the best route tree 13A. Since no routes to the network R8 are stored in the best route tree 13A, the route NEXTHOP (B) having been retrieved by the first routing engine 10 is stored into the best route tree 13A without carrying out the later mentioned comparison. The route NEXTHOP (B) is stored further into the kernel 14.

As illustrated in FIG. 4, when the third routing engine 12 stores the route NEXTHOP (D) to the network R8, having been retrieved by the third routing engine 12, into the routing software core 13, the route NEXTHOP (D) is stored in the third tree 12A associated with the third routing engine 12. Then, the routing software core 13 attempts to store the route NEXTHOP (D) into the best route tree 13A. However, since the route NEXTHOP (B) having been retrieved by the first routing engine 10 is already stored in the best route tree 13A, the routing software core 13 compares a priority of the third routing engine 12 to a priority of the first routing engine 10. Since a priority of the third routing engine 12 is lower than a priority of the first routing engine 10, the route NEXTHOP (D) having been retrieved by the third routing engine 12 is not stored into the best route tree 13A.

As illustrated in FIG. 5, when the second routing engine 11 stores the route NEXTHOP (C) to the network R8, having been retrieved by the second routing engine 11, into the routing software core 13, the route NEXTHOP (C) is stored in the second tree 11A associated with the second routing engine 11. Then, the routing software core 13 attempts to store the route NEXTHOP (C) into the best route tree 13A. However, since the route NEXTHOP (B) having been retrieved by the first routing engine 10 is already stored in the best route tree 13A, the routing software core 13 compares a priority of the second routing engine 11 to a priority of the first routing engine 10. Since a priority of the second routing engine 11 is higher than a priority of the first routing engine 10, the routing software core 13 removes the route NEXTHOP (B) out of the best route tree 13A, and stores the route NEXTHOP (C) having been retrieved by the second routing engine 11, into the best route tree 13A as a best route to the network R8. Then, the route NEXTHOP (B) having been retrieved by the first routing engine 10 is removed out of the kernel 14, and the route NEXTHOP (C) having been retrieved by the second routing engine 11 is stored into the kernel 14 as a best route to the network R8.

Hereinbelow is explained removal of the route NEXTHOP (C) having been retrieved by the second routing engine 11, out of the best route tree 13A.

First, the second tree 11A is retrieved in order to identify where the route NEXTHOP (C) is stored in the second tree 11A. Then, as illustrated in FIG. 6, the route NEXTHOP (C) is removed out of the second tree 11A.

Then, the best route tree 13A is retrieved in order to identify where the route NEXTHOP (C) is stored in the best route tree 13A. Then, as illustrated in FIG. 6, the route NEXTHOP (C) is removed out of the best route tree 13A.

Since only the route NEXTHOP (C) having been retrieved by the second routing engine 11 is stored in the best route tree 13A, no best route to the network R8 is stored in the best route tree 13A after removal of the route NEXTHOP (C) out of the best route tree 13A. Since any best route to the network R8 is no longer stored in the best route tree 13A, the route NEXTHOP (C) having been retrieved by the second routing engine 11 is removed out of the kernel 14.

Thereafter, a route to the network R8 is retrieved in the first and third trees 10A and 12A associated with the first and third routing engines 10 and 12, respectively. Then, a route to the network R8 having been found by retrieval of the first and third trees 10A and 12A is stored into the best route tree 13A as a new best route.

However, the above-mentioned conventional router 50 illustrated in FIG. 1 is accompanied with a problem that if a best route to a destination is removed out of the best route tree 13A, it would not be possible to transfer packets to the destination until a new best route is stored in the best route tree 13A. Accordingly, if it would take much time to retrieve a new best route and stored it into the best route tree 13A, packets could not be transferred to the destination for a long time, resulting in deterioration in reliability of the router 50.

If a best route is retrieved in a huge network, a tree in which a best route has to be found is also huge. Hence, a route to a destination has to be retrieved in such a huge tree, and a memory area into which the retrieved route is to be stored has to be retrieved in the best route tree 13A. The route is stored into the thus retrieved memory area in the best route 13A.

The above-mentioned conventional router 50 illustrated in FIG. 1 is accompanied with another problem as follows. If a plurality of routing engines stores routes to a common destination in trees associated with the routing engines, the routes have to be all removed out of the trees. This results in unnecessarily carrying out steps of storing the routes to the kernel 14 and removal of the routes out of the kernel 14.

For instance, if a route having been retrieved by the second routing engine 11 and having been stored in the best route tree 13A as a best route is removed out of the second tree 11A and the best route tree 13A, the first and third trees 10A and 12A associated with the first and third routing engines 10 and 12 are retrieved to find routes having been retrieved by the first and third routing engines 10 and 12, as a best route candidate. If the first tree 10A associated with the first routing engine 10 includes routes to the network R8 in a greater number than the third tree 12A associated with the third routing engine 12, the third tree 12A associated with the third routing engine 12 is first retrieved, because the third routing engine 12 has a lower priority than the same of the first routing engine 10. If a route to the destination, that is, the network R8, is found first in the third tree 12A associated with the third routing engine 12, the route is stored into the best route tree 13A as a best route, and further into the kernel 14.

If a route to the destination, that is, the network R8, is found in the first tree 10A associated with the first routing engine 10, the route having been retrieved by the third routing engine 12 is removed out of the best route tree 13A, and the route having been retrieved by the first routing engine 10 is stored into the best route tree 13A as a new best route. Thereafter, the route having been retrieved by the third routing engine 12 is removed out of the kernel 14, and the route having been retrieved by the first routing engine 10 is stored into the kernel 14.

As mentioned above, the conventional router 50 is accompanied with a problem that it takes much time for retrieving a new best route when an old best route is removed out of the best route tree 13A and a new best route is to be stored into the best route tree 13A.

The assignee of the present invention has suggested a system for registering routes in a multicast router for the purpose of reducing a load exerted on a kernel, in view of a problem of an increase in multicast routes through which data is transferred in accordance with multicast protocols. The system is comprised of multicast protocol engines receiving multicast routes from adjacent nodes, a kernel which stores only routes, transmits route information to the multicast protocol engines each time of receipt of multicast packets, and controls transfer of the received multicast packets, an application gate way demon which stores the routes in the kernel, and a transfer engine which receives route information from the kernel in parallel, and locally transfers multicast packets.

Japanese Patent Application Publication No. 11-503881, based on the international application PCT/US95/01313 which is further based on the U.S. patent application Ser. No. 08/213,710 filed on Mar. 16, 1994, has suggested a communication network including a plurality of switching nodes mutually connected to communication link, connected to one or more input link, and receiving data from the input link and transferring the received data to an output link. Each of the switching nodes includes first means for providing information about tree routing which identifies routing of data passing through the switching node, second means for defining a sequence of time bands each associated with one or more tree routing, third means for receiving information about one or more tree routing for each of the time bands, and fourth means for directing data transmitted from a sub-set of the input link to a sub-set of the output link in accordance with the information received from the third means within each of the time bands.

Japanese Patent Application Publication No. 6-261078 has suggested a method of retrieving a table in a communication system including a router comprised of a plurality of networks to which a plurality of terminals is connected, and a plurality of network interfaces for connecting the networks to one another. Each of the network interfaces includes a routing table and a cache memory used for retrieving the routing table. The methods includes the steps of receiving information about communication made among terminals connected to different networks, finding a destination address out of received packets, retrieving the routing table with the destination address being used as a retrieval key, and transmitting the information to other networks. The method further includes the steps of (a) storing a destination address in which a pointer to the entry in the routing table can be obtained, into CAM of the cache memory, (b) storing the pointer into a corresponding table having an entry which links with the entry of CAM, (c) when the routing table is retrieved again for a destination address having been previously retrieved, comparing the destination address to a destination address stored in CAM, (d) if CAM stores the destination address, obtaining a pointer to the routing table out of an entry of the corresponding table which links with an entry in which the destination address is stored.

Japanese Patent Application Publication No. 2000-49857 has suggested a router including (a) a retrieval memory having a first area in which a list of IP addresses of destination networks and a list of route numbers are stored, and a second area a list of IP addresses of destination hosts and a list of routes are stored, and (b) a retriever which retrieves the destination IP address list stored in the retrieval memory, in order to find a destination host address identical with a destination IP address included in received packets, or a destination network address including the destination host address, and transmits the received packets to a route associated with the thus retrieved destination host address or destination network address. In retrieval of the destination host address or destination network address, the retriever retrieves the destination IP addresses stored in the retrieval memory, by using a maximum length of a destination IP address included in a received packet, as a parameter.

However, the above-mentioned problems remain unsolved even in the above-mentioned apparatuses or methods.

### SUMMARY OF THE INVENTION

In view of the above-mentioned problems in the conventional router, it is an object of the present invention to provide a router which is capable of shortening a time necessary for retrieving a new best route to thereby reduce influence exerted on network communication.

It is also an object of the present invention to provide a method of administrating routes through which data is transferred, and a computer program for doing the same.

In one aspect of the present invention, there is provided a router including (a) a plurality of unicast protocol engines each receiving a unicast route from an adjacent node, (b) a routing software core which stores the unicast route into trees associated with the unicast protocol engines, selects a best route among unicast routes received by the unicast protocol engines, in accordance with a priority assigned to the unicast protocol engines, and stores the best route into a best route tree, and (c) a kernel which receives the best route from the routing software core to carry out routing control, wherein the routing software core, when a plurality of routes addressed to a common destination is stored into the trees, registers a route retrieved by a unicast protocol engine having a highest priority, into the best route tree as a best route, applies a priority to routes retrieved by other unicast protocol engines, in accordance with a priority assigned to the unicast protocol engines, and registers the routes into the best route tree together with the best route as a best route candidate.

For instance, the routing software core, when the best route registered in the best route tree is canceled, selects a best route candidate having a highest priority among best route candidates registered in the best route tree, as a new best route.

In another aspect of the present invention, there is provided a method of administrating routes through which data is transferred, including the steps of (a) receiving unicast routes from adjacent nodes through a plurality of unicast protocol engines, (b) storing the unicast route into trees associated with the unicast protocol engines, (c) selecting a best route among unicast routes received by the unicast protocol engines, in accordance with a priority assigned to the unicast protocol engines, and (d) carrying out routing control in accordance with the best route, wherein the step (c) includes the steps of (c1) registering when a plurality of routes addressed to a common destination is stored into the trees, a route retrieved by a unicast protocol engine having a highest priority, into the best route tree as a best route, (c2) applying a priority to routes retrieved by other unicast protocol engines, in accordance with a priority assigned to the unicast protocol engines, and (c3) registering the routes into the best route tree together with the best route as a best route candidate.

It is preferable that the method further includes the step of, when the best route registered in the best route tree is canceled, selecting a best route candidate having a highest priority among best route candidates registered in the best route tree, as a new best route.

In still another aspect of the present invention, there is provided a program readable by a computer for causing the computer to carry out a method of administrating routes through which data is transferred, the program carrying out the steps of (a) receiving unicast routes from adjacent nodes through a plurality of unicast protocol engines, (b) storing the unicast route into trees associated with the unicast protocol engines, (c) selecting a best route among unicast routes received by the unicast protocol engines, in accordance with a priority assigned to the unicast protocol engines, and (d) carrying out routing control in accordance with the best route, wherein the step (c) includes the steps of (c1) registering when a plurality of routes addressed to a common destination is stored into the trees, a route retrieved by a unicast protocol engine having a highest priority, into the best route tree as a best route, (c2) applying a priority to routes retrieved by other unicast protocol engines, in accordance with a priority assigned to the unicast protocol engines, and (c3) registering the routes into the best route tree together with the best route as a best route candidate.

It is preferable that the program further carries out the step of, when the best route registered in the best route tree is canceled, selecting a best route candidate having a highest priority among best route candidates registered in the best route tree, as a new best route.

The advantages obtained by the aforementioned present invention will be described hereinbelow.

In the router in accordance with the present invention, at least one second best route is in advance stored in the best route tree together with the best route to a destination. Accordingly, even if it becomes necessary to exchange a best route, it is no longer necessary to retrieve a new best route. Thus, it is possible to omit a time necessary for retrieving a new best route.

In the conventional router illustrated in FIG. 1, after a best route has been removed out of the best route tree 13A, the first and third trees 10A and 12A are retrieved for finding a new best route. If the first tree 10A associated with the first routing engine 10 having a higher priority than the same of the third routing engine 12 stores routes in the greater number than routes stored in the third tree 12A associated with the third routing engine 12, a route retrieved by the third routing engine 12 is first stored into the best route tree 13A and further into the kernel 14, and immediately thereafter, a route retrieved by the first routing engine 10 is stored into the best route tree 13A and further into the kernel 14. Thus, storage of a best route into the kernel 14 and removal of a best route out of the kernel 14 are repeatedly carried out.

In contrast, in the router in accordance with the present invention, at least one second best route is in advance stored in the best route tree together with a best route to a destination. As a second best route is selected a route retrieved by a routing engine having a priority higher than the same of other routing engines. Hence, routes retrieved by routing engines having a priority lower than a priority of a certain routing engine are not selected as a best route, resulting in that it is possible to prevent repetition of storage of a best route into a kernel and removal of a best route out of a kernel.

In addition, since a next best route is in advance known, it is necessary to only retrieve both a tree in which the next best tree is stored and the best route tree, when a best route is to be exchanged. It is no longer necessary to retrieve all of trees, even if a lot of routes are stored in the trees. This ensures that a time necessary for retrieving trees can be shortened.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a conventional router.

FIG. 2 illustrates an example of a network.

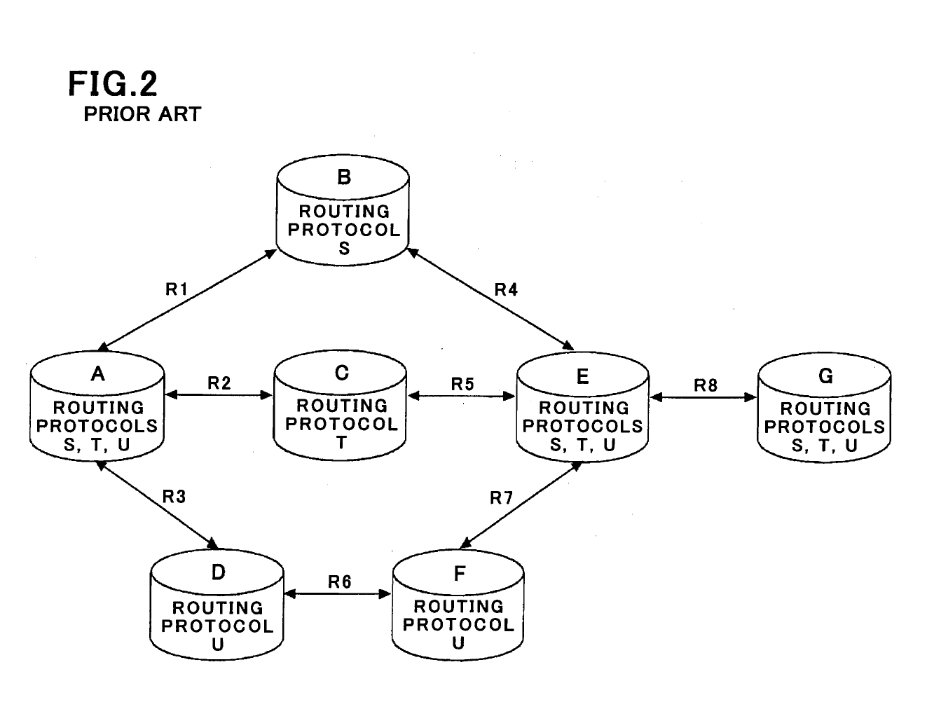

FIG. 3 is a block diagram of the conventional router, similarly to FIG. 1, showing an operation of the same.

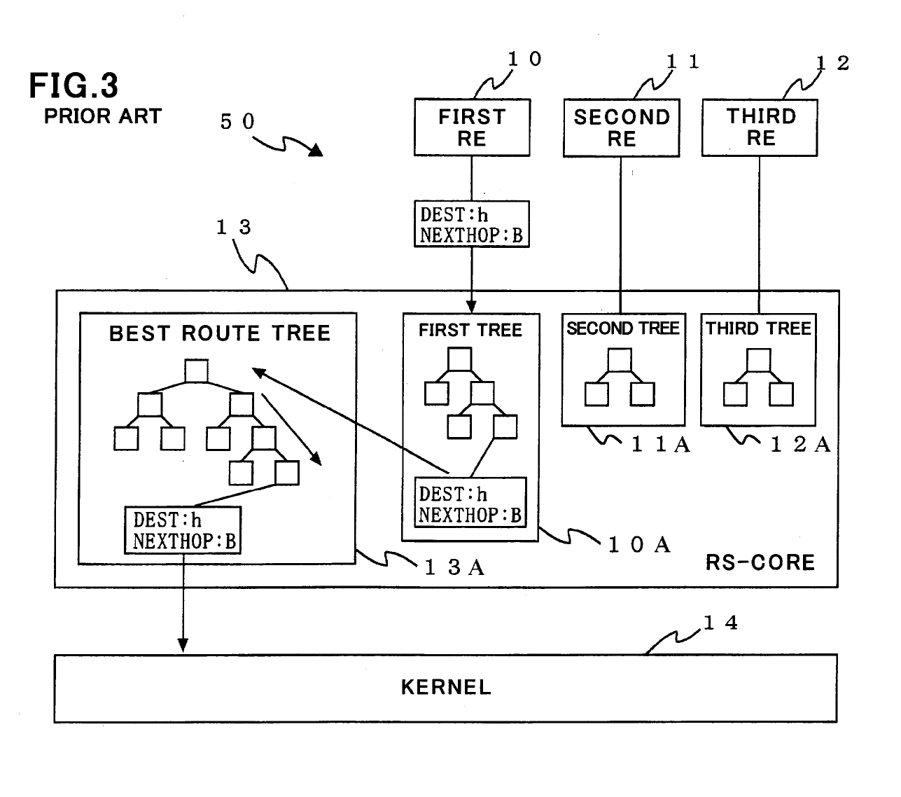

FIG. 4 is a block diagram of the conventional router, similarly to FIG. 1, showing an operation of the same.

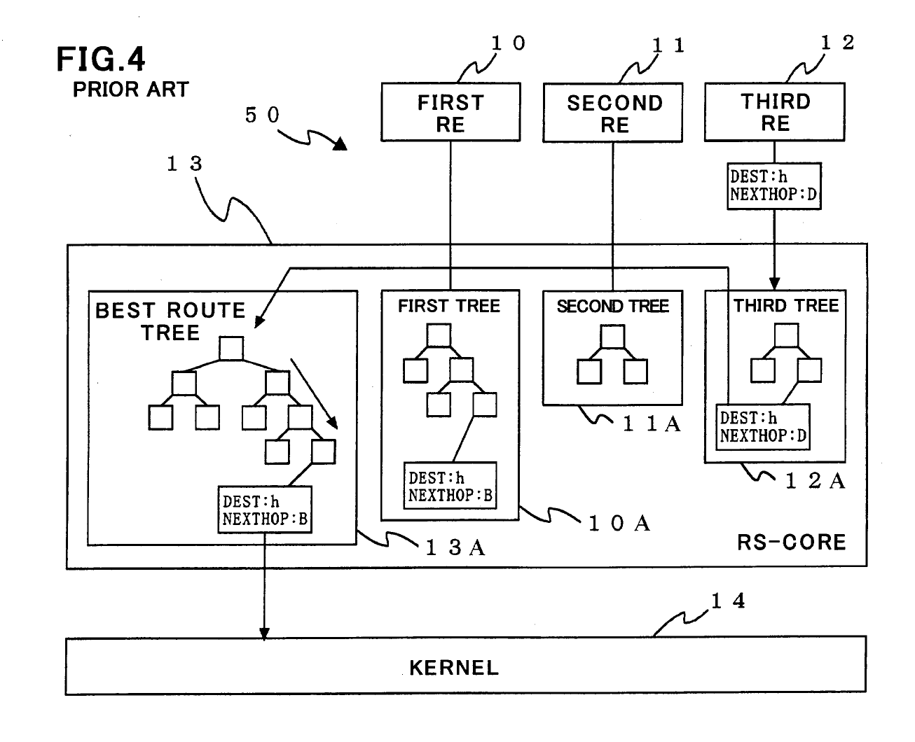

FIG. 5 is a block diagram of the conventional router, similarly to FIG. 1, showing an operation of the same.

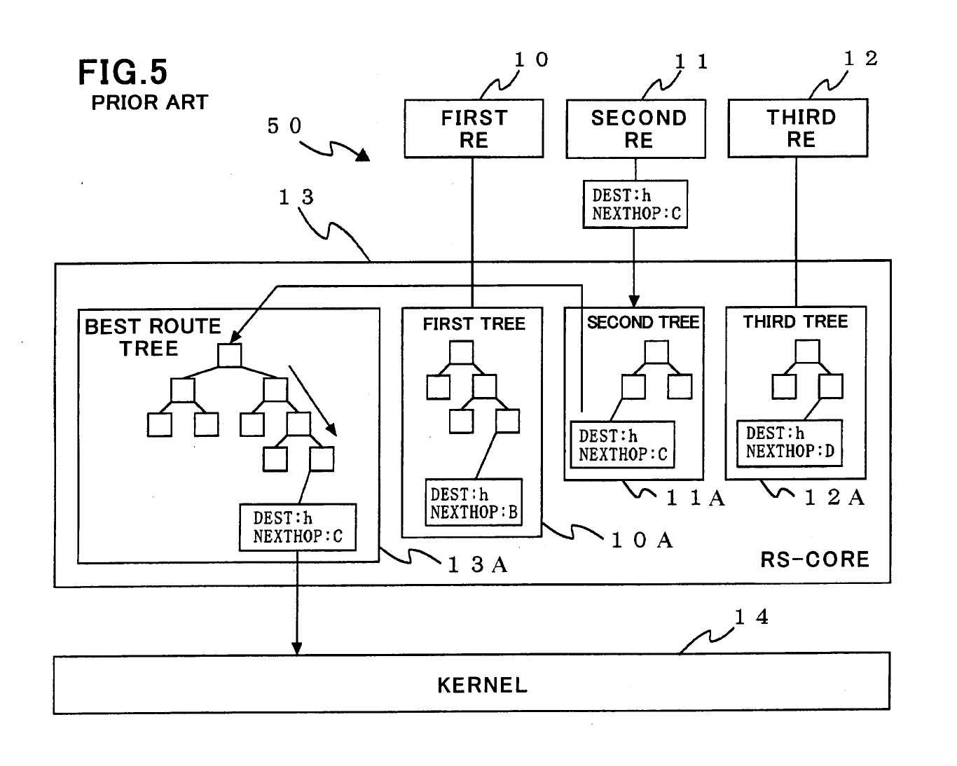

FIG. 6 is a block diagram of the conventional router, similarly to FIG. 1, showing an operation of the same.

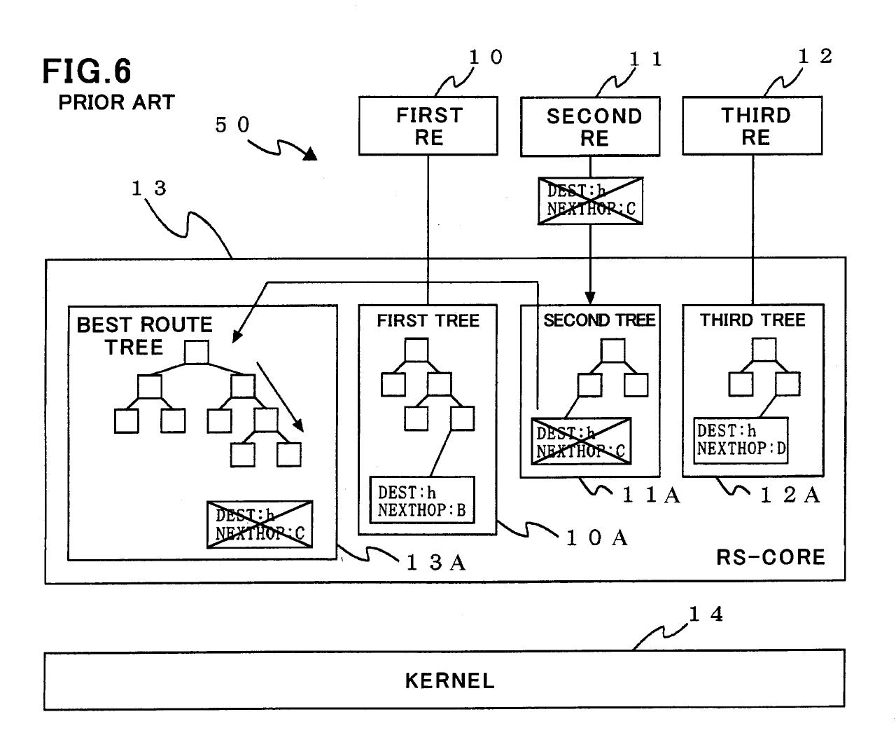

FIG. 7 is a block diagram of a router in accordance with a first embodiment of the present invention.

FIG. 8 illustrates an example of a network.

FIG. 9 is a block diagram of a router in accordance with a preferred embodiment of the present invention, similarly to FIG. 7, showing an operation of the same.

FIG. 10 is a block diagram of a router in accordance with a preferred embodiment of the present invention, similarly to FIG. 7, showing an operation of the same.

FIG. 11 is a block diagram of a router in accordance with a preferred embodiment of the present invention, similarly to FIG. 7, showing an operation of the same.

FIG. 12 is a block diagram of a router in accordance with a preferred embodiment of the present invention, similarly to FIG. 7, showing an operation of the same.

### DESCRIPTION OF THE PREFERRED EMBODIMENTS

A preferred embodiment in accordance with the present invention will be explained hereinbelow with reference to drawings.

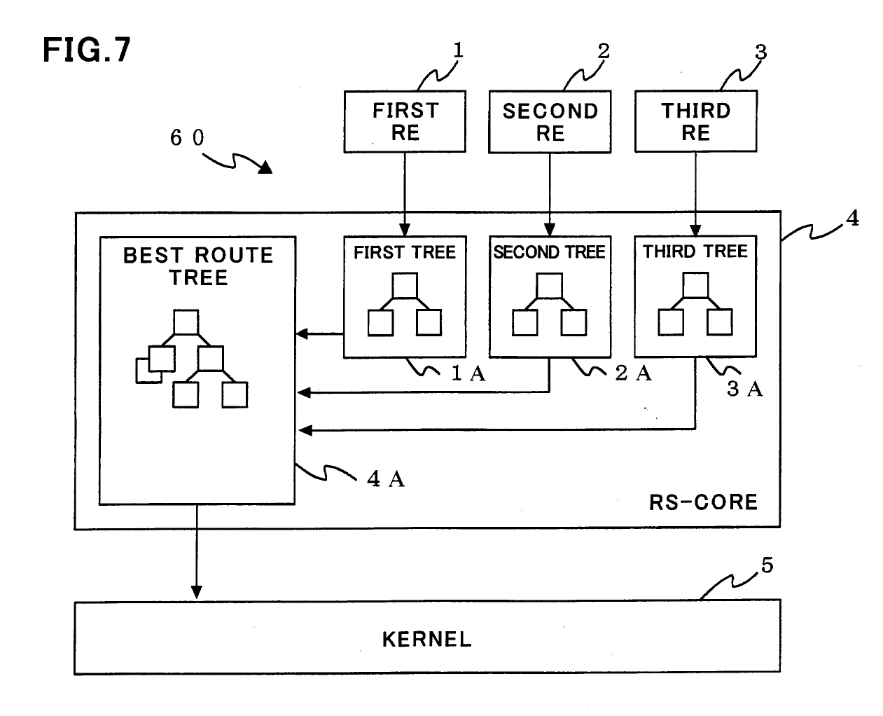

FIG. 7 is a block diagram of a router 60 in accordance with a first embodiment of the present invention.

The router 60 is comprised of a first routing engine (RE) 1, a second routing engine (RE) 2, a third routing engine (RE) 3, a demon routing software core (RS-CORE) 4 which merges routes retrieved for each of destinations, and registers the routes into a later mentioned kernel 5, and a kernel 5 which stores routes provided from the routing software core 4, into a forwarding route table (not illustrated) to thereby carry out routing control.

Each of the first to third routing engines 1, 2 and 3 is comprised of a unicast protocol engine, and operates in accordance with a routing protocol different from other ones.

The routing software core (RS-CORE) 4 includes a first tree 1A in which a route retrieved by the first routing engine 10 is stored, a second tree 2A in which a route retrieved by the second routing engine 2 is stored, a third tree 3A in which a route retrieved by the third routing engine 3 is stored, and a best route tree 4A in which a best route found among routes stored in the first to third trees 1A, 2A and 3A is stored.

Each of the first to third routing engines 1, 2 and 3 receives a unicast route from an adjacent node in accordance with the routing protocol, and stores the thus received unicast route into the associated tree 1A, 2A and 3A, respectively.

The routing software core 4 administrates the unicast routes having been retrieved by the first to third routing engines 1, 2 and 3 and stored in the first to third trees 1A, 2A and 3A. In addition, the routing software core 4 merges routes to each of destinations in accordance with a priority applied to each of the first to third routing engines 1, 2 and 3, finds a best route among the routes stored in the first to third trees 1A, 2A and 3A, and stores the thus found best route into the best route tree 4A.

Specifically, a best route to be stored into the best route tree 4A is selected as follows.

When a plurality of routes to a common destination is retrieved by the first to third routing engines 1 to 3, a route having been retrieved by a routing engine having a highest priority among priorities of the first to third routing engines 1 to 3 is selected as a best route. The thus selected best route is stored into the best route tree 4A. Concurrently with storage of a best route into the best route tree 4A, a second best route NEXTHOP is stored further into the best route tree 4A as a best route candidate in association with the best route. Herein, a second best route indicates a route having a second highest priority among priorities of the first to third routing engines 1 to 3. The second best route NEXTHOP is stored in the best route tree 4A as having an address or destination identical with the same of the best route. Among the best route and the second best route stored in the best route tree 4A, only the best route is registered in the kernel 5.

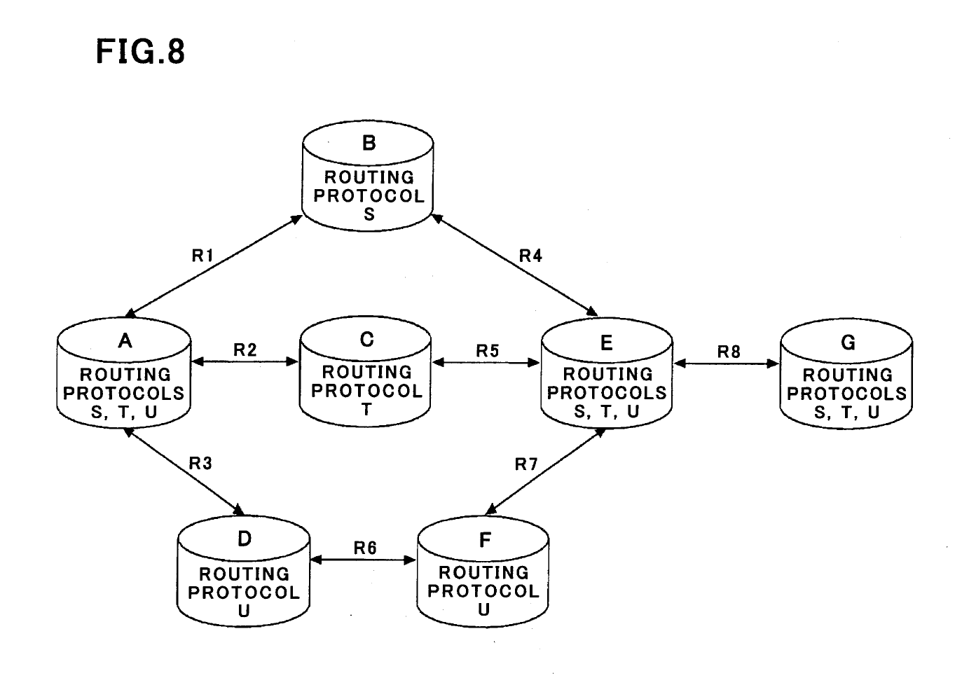

Hereinbelow is explained an operation of the router 60 with reference to FIGS. 8 to 12.

FIG. 8 illustrates a network structure in which seven routers A to G are connected to one another through networks R1 to R8.

When the router A transfers packets to the network R8 in the network structure illustrated in FIG. 8, packets can be transferred through the following three routes. In a first route, packets are transferred to the network R8 through the routers B and E. In a second route, packets are transferred to the network R8 through the routers C and E. In a third route, packets are transferred to the network R8 through the routers D, F and E.

The first to third routing engines 1 to 3 operate in accordance with routing protocols different from one another. The first routing engine 1 retrieves NEXTHOP (B) as a route to a destination, that is, the network R8 in accordance with a routing protocol S, and stores the route NEXTHOP (B) into the first tree 1A in the routing software core 4. The second routing engine 2 retrieves NEXTHOP (C) as a route to a destination, that is, the network R8 in accordance with a routing protocol T, and stores the route NEXTHOP (C) into the second tree 2A in the routing software core 4. The third routing engine 3 retrieves NEXTHOP (D) as a route to a destination, that is, the network R8 in accordance with a routing protocol U, and stores the route NEXTHOP (D) into the third tree 3A in the routing software core 4.

It is assumed hereinbelow that the second routing engine 2 has a highest priority, the first routing engine 1 has a second highest priority, and the third routing engine 1 has a lowest priority in the routing software core 4. It is further assumed that the best route tree 4A initially stores no routes.

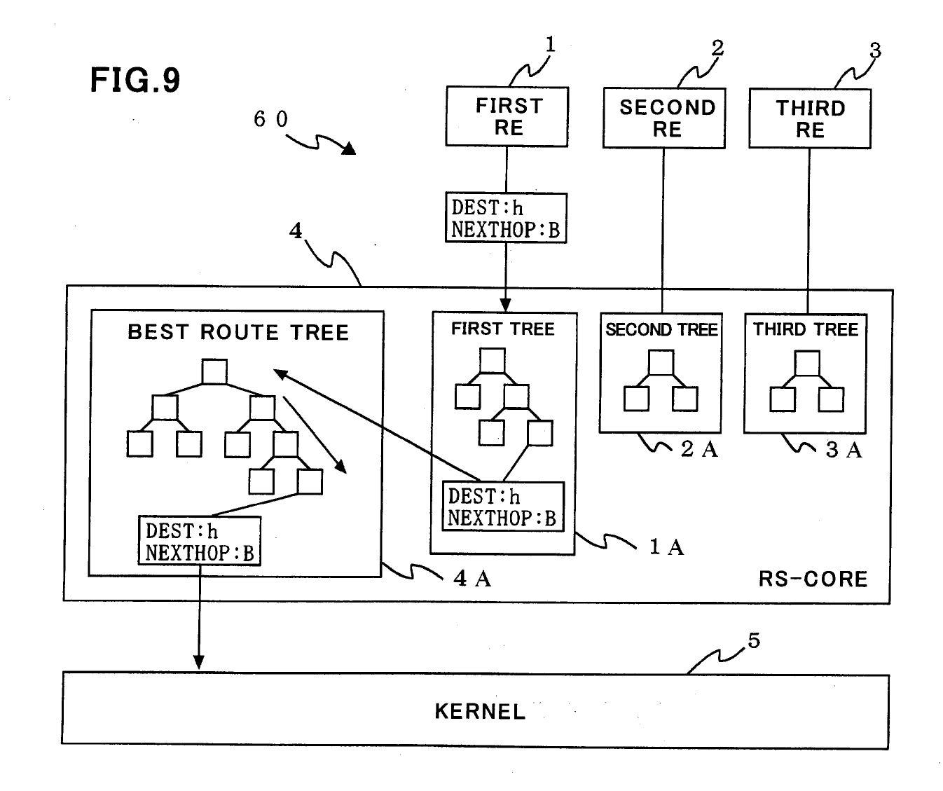

As illustrated in FIG. 9, when the first routing engine 1 stores the route NEXTHOP (B) addressed to the network R8, having been retrieved by the first routing engine 1, into the routing software core 4, the route NEXTHOP (B) is stored in the first tree 1A associated with the first routing engine 1. Then, the route NEXTHOP (B) is stored into the best route tree 4A. Since no routes to the network R8 are stored in the best route tree 4A, the route NEXTHOP (B) having been retrieved by the first routing engine 1 is stored into the best route tree 4A without carrying out the later mentioned comparison. The route NEXTHOP (B) is stored further into the kernel 5 from the best route tree 4A.

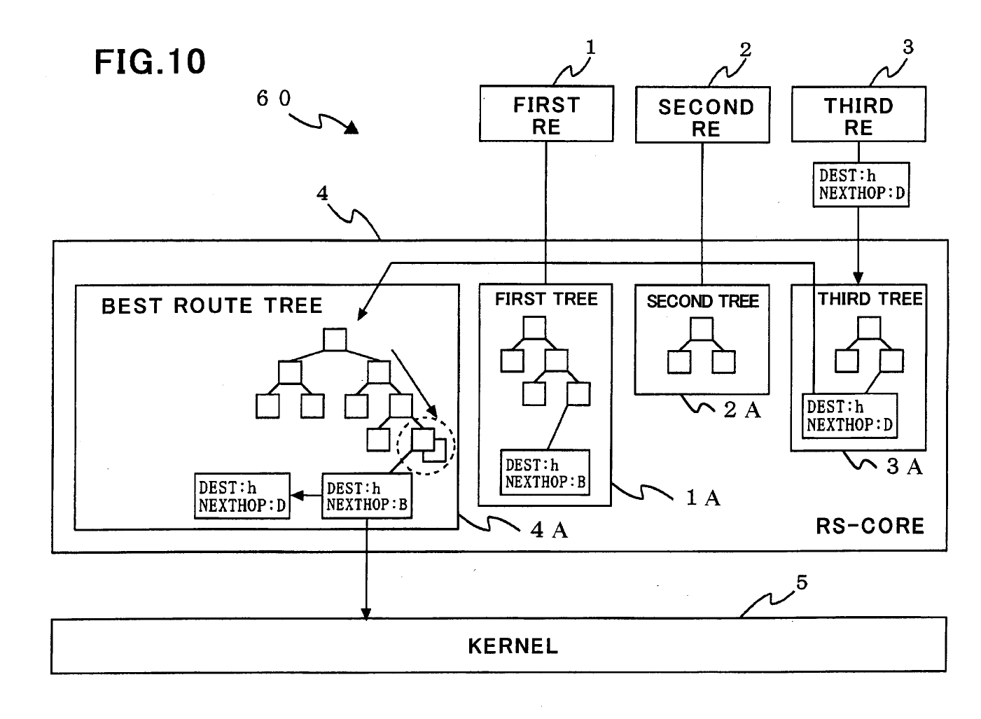

As illustrated in FIG. 10, when the third routing engine 3 stores the route NEXTHOP (D) to the network R8, having been retrieved by the third routing engine 3, into the routing software core 4, the route NEXTHOP (D) is stored in the third tree 3A associated with the third routing engine 3.

Then, the routing software core 4 attempts to store the route NEXTHOP (D) into the best route tree 4A. However, since the route NEXTHOP (B) having been retrieved by the first routing engine 1 is already stored in the best route tree 4A, the routing software core 4 compares a priority of the third routing engine 3 to a priority of the first routing engine 1. Since a priority of the third routing engine 3 is lower than a priority of the first routing engine 1, the route NEXTHOP (D) having been retrieved by the third routing engine 3 is stored into the best route tree 4A as a best route candidate or a second best route to the network R8. Thus, the route NEXTHOP (B) is stored as a best route, and the route NEXTHOP (D) is stored as a second best route both in the best route tree 4A.

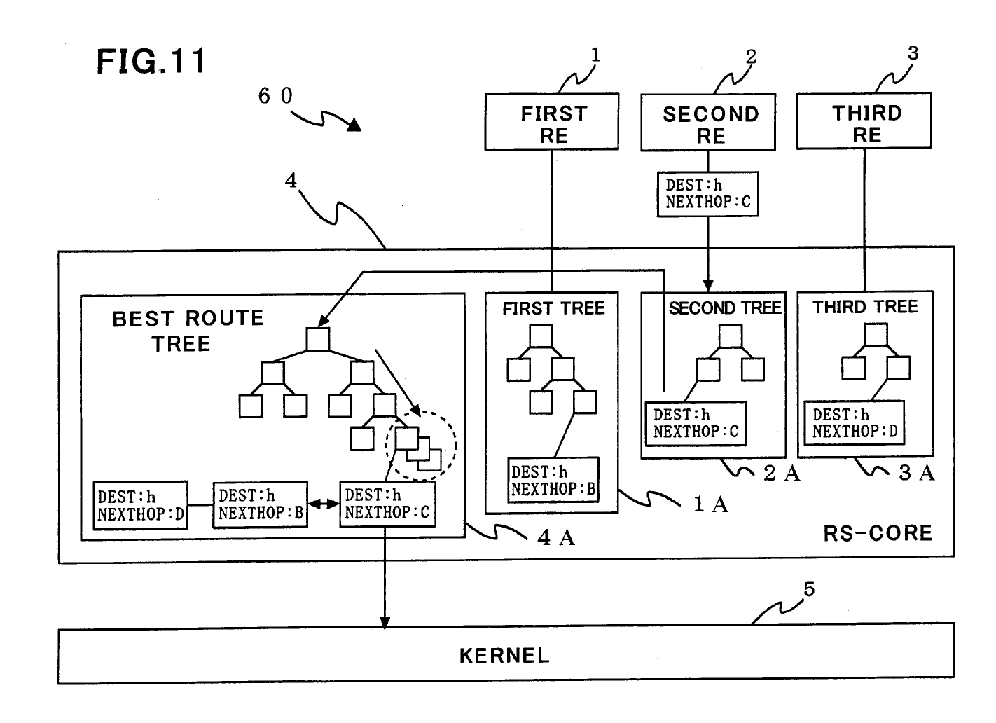

As illustrated in FIG. 11, when the second routing engine 2 stores the route NEXTHOP (C) to the network R8, having been retrieved by the second routing engine 2, into the routing software core 4, the route NEXTHOP (C) is stored in the second tree 2A associated with the second routing engine 2.

Then, the routing software core 4 attempts to store the route NEXTHOP (C) into the best route tree 4A. However, since the route NEXTHOP (B) having been retrieved by the first routing engine 1 is already stored in the best route tree 4A, the routing software core 4 compares a priority of the second routing engine 2 to a priority of the first routing engine 1. Since a priority of the second routing engine 2 is higher than a priority of the first routing engine 1, the route NEXTHOP (C) having been retrieved by the second routing engine 2 is stored into the best route tree 4A as a best route to the network R8.

The route NEXTHOP (B) having been retrieved by the first routing engine 1 and the route NEXTHOP (D) having been retrieved by the third routing engine 3 are stored in the best route tree 4A as second best routes. Specifically, the route NEXTHOP (C) having been retrieved by the second routing engine 2 is stored into the best route tree 4A as a best route to the network R8, and concurrently, the routes NEXTHOP (B) and NEXTHOP (D) are also stored into the best route tree 4A with a priority being applied to them in accordance with a priority applied to the first and third routing engines 1 and 3.

Since a priority applied to the first routing engine 1 is higher than a priority applied to the third routing engine 3, if the route NEXTHOP (C) stored in the best route tree 4A as a best route to the network R8 is removed out of the best route tree 4A, the route NEXTHOP (B) having been retrieved by the first routing engine 1 is newly selected as a best route to the network R8. In addition, since the route NEXTHOP (B) having been retrieved by the first routing engine 1 is different from the route NEXTHOP (C) having been retrieved by the second routing engine 2, the route NEXTHOP (B) having been retrieved by the first routing engine 1 is stored further into the kernel 5.

Hereinbelow is explained removal of the route NEXTHOP (C) having been retrieved by the second routing engine 2, out of the best route tree 4A.

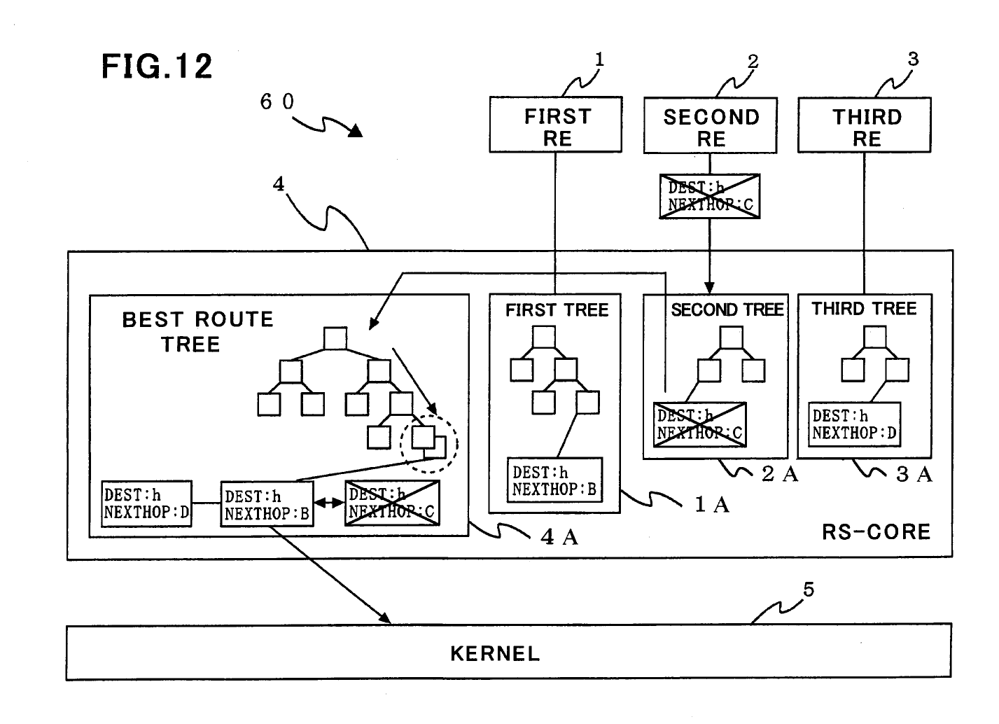

First, the second tree 2A is retrieved in order to identify where the route NEXTHOP (C) is stored in the second tree 2A. Then, as illustrated in FIG. 12, the route NEXTHOP (C) is removed out of the second tree 2A.

Then, the best route tree 4A is retrieved in order to identify where the route NEXTHOP (C) is stored in the best route tree 4A. Then, as illustrated in FIG. 12, the route NEXTHOP (C) is removed out of the best route tree 4A. At the same time of the removal of the route NEXTHOP (C) out of the best route tree 4A, a newly selected best route is stored into the best route tree 4A.

At this stage, the route NEXTHOP (B) having been retrieved by the first routing engine 1 and the route NEXTHOP (D) having been retrieved by the third routing engine 3 are stored in the best route tree 4A as second best routes. Hence, it would be possible to concurrently remove a best route presently stored in the best route tree 4A and select a new best route which has been stored in the best route tree 4A as a second best tree, merely by retrieving the best route presently stored in the best route tree 4A. Specifically, it would be possible to concurrently remove the route NEXTHOP (C) having been retrieved by the second routing engine 2, out of the best route tree 4A, and select the route NEXTHOP (B) having been retrieved by the first routing engine 1, as a new best route.

After the removal of the route NEXTHOP (C) out of the best route tree 4A and the selection of the route NEXTHOP (B) as a new best route, the route NEXTHOP (B) is registered into the kernel 5.

As mentioned above, in the router 60 in accordance with the first embodiment, at least one second best route is in advance stored in the best route tree 4A together with the best route to a destination. Accordingly, even if it becomes necessary to exchange a best route, it is no longer necessary to retrieve a new best route. Thus, it is possible to omit a time necessary for retrieving a new best route.

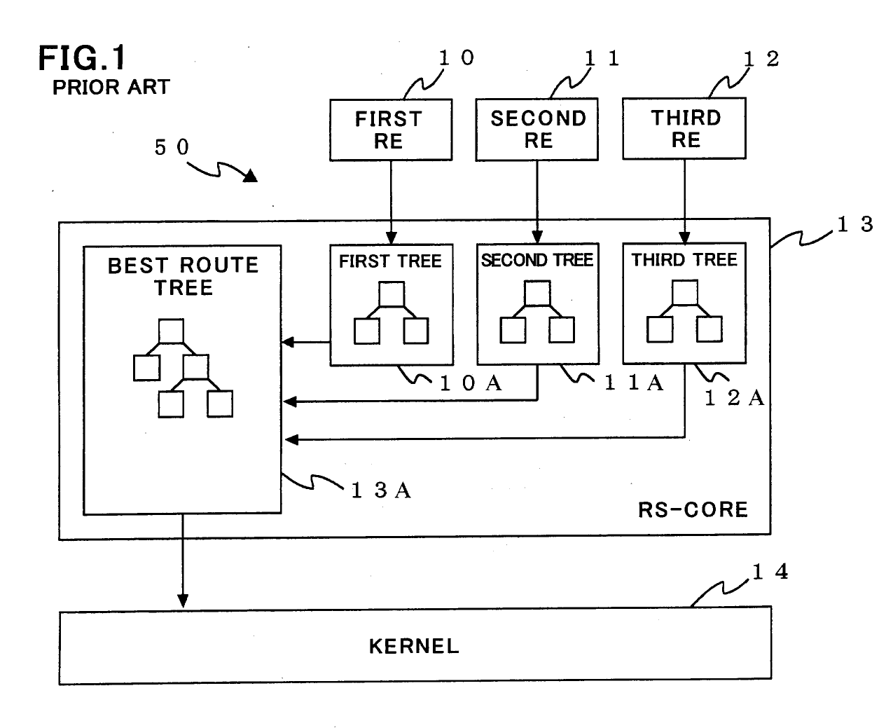

As mentioned earlier, in the conventional router 50 illustrated in FIG. 1, after a best route has been removed out of the best route tree 13A, the first and third trees 10A and 12A are retrieved to find a new best route. If the first tree 10A associated with the first routing engine 10 having a higher priority than the same of the third routing engine 12 stores routes in the greater number than routes stored in the third tree 12A associated with the third routing engine 12, a route retrieved by the third routing engine 12 is first stored into the best route tree 13A and further into the kernel 14, and immediately thereafter, a route retrieved by the first routing engine 10 is stored into the best route tree 13A and further into the kernel 14. Thus, storage of a best route into the kernel 14 and removal of a best route out of the kernel 14 are repeatedly carried out.

In contrast, in the router 60 in accordance with the first embodiment, at least one second best route is in advance stored in the best route tree 4A together with a best route to a destination. As a second best route is selected a route retrieved by a routing engine having a priority higher than the same of other routing engines. Hence, routes retrieved by routing engines having a priority lower than a priority of a certain routing engine are not selected as a best route, resulting in that it is possible to prevent repetition of storage of a best route into a kernel and removal of a best route out of a kernel.

In addition, since a next best route is in advance known, it is necessary to only retrieve both a tree in which the next best tree is stored and the best route tree 4A, when a best route is to be exchanged. It is no longer necessary to retrieve all of trees, even if a lot of routes are stored in the trees. This ensures that a time necessary for retrieving trees can be shortened.

The routing software core 4 has such a structure as mentioned above, and operates in such a manner as mentioned above.

The routing software core 4 may be accomplished by a data processor such as a personal computer or a work station, and a program to carry out functions of the routing software core 4. Such a program may be presented through a recording medium readable by a computer. The program is read out into a data processor when the data processor starts its operation. By controlling an operation of the data processor, the routing software core 4 can be accomplished in the data processor.

The performance of the routing software core 4 may be accomplished as a program including various commands, and be presented through a recording medium readable by a computer.

In the specification, the term “recording medium” means any medium which can record data therein.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-51243 filed on Feb. 27, 2002 including specification, claims, drawings and summary is incorporated herein by reference in its entirety.

What is claimed is:

1. A router comprising:
(a) a plurality of unicast protocol engines each receiving a unicast route from an adjacent node;
(b) a routing software core which stores said unicast route into trees associated with said unicast protocol engines, selects a best route among unicast routes received by said unicast protocol engines, in accordance with a priority assigned to said unicast protocol engines, and stores said best route into a best route tree; and
(c) a kernel which receives said best route from said routing software core to carry out routing control,
wherein said routing software core, when a plurality of routes addressed to a common destination is stored into said trees, registers a route retrieved by a unicast protocol engine having a highest priority, into said best route tree as a best route, applies a priority to routes retrieved by other unicast protocol engines, in accordance with a priority assigned to said unicast protocol engines, and registers said routes into said best route tree together with said best route as a best route candidate.

2. The router as set forth in claim 1, wherein said routing software core, when said best route registered in said best route tree is canceled, selects a best route candidate having a highest priority among best route candidates registered in said best route tree, as a new best route.

3. A method of administrating routes through which data is transferred, comprising the steps of:
(a) receiving unicast routes from adjacent nodes through a plurality of unicast protocol engines;
(b) storing said unicast route into trees associated with said unicast protocol engines;
(c) selecting a best route among unicast routes received by said unicast protocol engines, in accordance with a priority assigned to said unicast protocol engines; and
(d) carrying out routing control in accordance with said best route,
wherein said step (c) includes the steps of
(c1) registering when a plurality of routes addressed to a common destination is stored into said trees, a route retrieved by a unicast protocol engine having a highest priority, into said best route tree as a best route;
(c2) applying a priority to routes retrieved by other unicast protocol engines, in accordance with a priority assigned to said unicast protocol engines; and
(c3) registering said routes into said best route tree together with said best route as a best route candidate.

4. The method as set forth in claim 3, further comprising the step of, when said best route registered in said best route tree is canceled, selecting a best route candidate having a highest priority among best route candidates registered in said best route tree, as a new best route.

5. A program readable by a computer for causing said computer to carry out a method of administrating routes through which data is transferred, said program carrying out the steps of:
(a) receiving unicast routes from adjacent nodes through a plurality of unicast protocol engines;
(b) storing said unicast route into trees associated with said unicast protocol engines;
(c) selecting a best route among unicast routes received by said unicast protocol engines, in accordance with a priority assigned to said unicast protocol engines; and
(d) carrying out routing control in accordance with said best route,
wherein said step (c) includes the steps of
(c1) registering when a plurality of routes addressed to a common destination is stored into said trees, a route retrieved by a unicast protocol engine having a highest priority, into said best route tree as a best route;
(c2) applying a priority to routes retrieved by other unicast protocol engines, in accordance with a priority assigned to said unicast protocol engines; and
(c3) registering said routes into said best route tree together with said best route as a best route candidate.

6. The program as set forth in claim 5, wherein said program further carries out the step of, when said best route registered in said best route tree is canceled, selecting a best route candidate having a highest priority among best route candidates registered in said best route tree, as a new best route.
